(19) United States
(12) Patent Application Publication
(10) Pub. No.: US 2026/0239310 A1
(43) Pub. Date: Aug. 13, 2026

(54) UPLINK TRANSMISSION METHOD AND APPARATUS, AND STORAGE MEDIUM

(71) Applicant: Beijing Xiaomi Mobile Software Co., Ltd., Beijing (CN)

(72) Inventors: Lei WANG, Beijing (CN); Shengxiang GUO, Beijing (CN)

(73) Assignee: Beijing Xiaomi Mobile Software Co., Ltd., Beijing (CN)

(21) Appl. No.: 19/156,828

(22) PCT Filed: Feb. 17, 2023
(86) PCT No.: PCT/CN2023/076939

§ 371 Date: Aug. 14, 2025

(51) Int. Cl. H04W 72/0446; H04W 72/21

(52) U.S. Cl. CPC H04W 72/0446; H04W 72/21

(57) ABSTRACT

A method for an uplink transmission, performed by a terminal device, includes: receiving transmission conflict information sent by a network device; determining a first time domain position, where the first time domain position comprises a time domain position shared by an uplink frequency domain resource and a downlink frequency domain resource; and controlling the uplink transmission according to the transmission conflict information and the first time domain position.

### CROSS REFERENCE TO RELATED APPLICATIONS

The present application is a U.S. National Stage of International Application No. PCT/CN2023/076939, filed on Feb. 17, 2023, all contents of which are incorporated herein by reference in their entireties for all purposes.

### TECHNICAL FIELD

The present disclosure relates to the field of communication technology, and in particular, to a method and apparatus for an uplink transmission, and a storage medium.

### BACKGROUND

In a wireless communication system, different frequencies are used in the frequency division duplex (FDD) communication technology to perform uplink communication and downlink communication, and different slots are used in the time division duplex (TDD) communication technology to perform uplink communication and downlink communication. In the full duplex (FD, also referred to as XDD) communication technology, which is different from the FDD communication technology and the TDD communication technology, the uplink transmission and the downlink transmission may be performed at the same slot and the same frequency, thus improving the utilization rate of spectrum resources.

### SUMMARY

According to a first aspect of the embodiments of the present disclosure, there is provided a method for an uplink transmission performed by a terminal device, and the method includes:
receiving transmission conflict information sent by a network device;
determining a first time domain position, where the first time domain position includes a time domain position shared by an uplink frequency domain resource and a downlink frequency domain resource; and
controlling the uplink transmission according to the transmission conflict information and the first time domain position.

According to a second aspect of the embodiments of the present disclosure, there is provided a method for an uplink transmission, performed by a network device, and the method includes:
sending transmission conflict information to a terminal device, where the transmission conflict information indicates the terminal device to determine a first time domain position and control the uplink transmission, and the first time domain position includes a time domain position shared by an uplink frequency domain resource and a downlink frequency domain resource.

According to a third aspect of the embodiments of the present disclosure, there is provided an apparatus for an uplink transmission, including:
a processor; and
a memory for storing an executable instruction by the processor;
where the processor is configured to perform steps of the method for the uplink transmission provided in the first aspect of the present disclosure.

According to a fourth aspect of the embodiments of the present disclosure, there is provided an apparatus for an uplink transmission, including:
a processor; and
a memory for storing an executable instruction by the processor;
where the processor is configured to perform the steps of the method for the uplink transmission provided in the second aspect of the present disclosure.

According to a fifth aspect of the embodiments of the present disclosure, there is provided a computer-readable storage medium having a computer program instruction stored thereon, where the computer program instruction, when executed by a processor, causes to implement the steps of the method for the uplink transmission provided in the first aspect of the present disclosure.

According to an sixth aspect of the embodiments of the present disclosure, there is provided a computer-readable storage medium having a computer program instruction stored thereon, where the computer program instruction, when executed by a processor, causes to implement the steps of the method for the uplink transmission provided in the second aspect of the present disclosure.

It is to be understood that both the foregoing general description and the following detailed description are exemplary and explanatory only and are not restrictive of the present disclosure.

### BRIEF DESCRIPTION OF THE DRAWINGS

The accompanying drawings here, which are incorporated in and constitute a part of the description, illustrate embodiments consistent with the present disclosure and, together with the description, serve to explain the principles of the present disclosure.

FIG. 1 is a schematic diagram of a communication system according to some embodiments of the present disclosure.

FIG. 2 is a schematic diagram of a communication slot according to some embodiments of the present disclosure.

FIG. 3 is a flowchart of a method for an uplink transmission according to some embodiments of the present disclosure.

FIG. 4 is a flowchart of a method for an uplink transmission according to some embodiments of the present disclosure.

FIG. 5 is a flowchart of a method for an uplink transmission according to some embodiments of the present disclosure.

FIG. 6 is a flowchart of a method for an uplink transmission according to some embodiments of the present disclosure.

FIG. 7 is a flowchart of a method for an uplink transmission according to some embodiments of the present disclosure.

FIG. 8 is a flowchart of a method for an uplink transmission according to some embodiments of the present disclosure.

FIG. 9 is a flowchart of a method for an uplink transmission according to some embodiments of the present disclosure.

FIG. 10 is a flowchart of a method for an uplink transmission according to some embodiments of the present disclosure.

FIG. 11 is a flowchart of a method for an uplink transmission according to some embodiments of the present disclosure.

FIG. 12 is a block diagram of an apparatus for an uplink transmission according to some embodiments of the present disclosure.

FIG. 13 is a block diagram of an apparatus for an uplink transmission according to some embodiments of the present disclosure.

FIG. 14 is a block diagram of an apparatus for an uplink transmission according to some embodiments of the present disclosure.

### DETAILED DESCRIPTION

Example embodiments will be described in detail here, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the present disclosure. Instead, they are merely examples of apparatuses and methods consistent with some aspects of the present disclosure as detailed in the appended claims.

It should be noted that all actions for acquiring signals, information or data in the present disclosure are performed on the premise of conforming to the corresponding data protection regulation policy of the country of the location, and obtaining the authorization by the owner of the corresponding apparatus.

In the description of the present disclosure, terms such as “first” and “second” used in the present disclosure are used to distinguish between similar objects, and are not necessarily to be understood as a specific order or sequence. In addition, the same reference numbers in different drawings represent the same elements in the description of the drawings unless otherwise represented.

In the description of the present disclosure, unless otherwise represented, “a plurality of” means two or more than two, and other quantifiers are similar with it. The term “at least one”, “one or more”, or the like, refers to any combination of these items, including any combination of a single item or a plurality of items. For example, “at least one” may represent any quantity. For another example, one or more of a, b, and c may represent: a, b, c, a-b, a-c, b-c, or a-b-c, where a, b, and c may be singular or plural. “And/or” is an association relationship describing associated objects, indicating that there may be three relationships. For example, A and/or B may indicate three relationships that A exists alone, both A and B exist, and B exists alone, where A and B may be singular or plural. The character “/” indicates an “or” relationship between the associated objects. The singular forms “a”, “an”, “the”, and “said” are intended to include the plural forms as well, unless the context clearly indicates other meanings.

Although the operations or steps are described in a specific order in the embodiments of the present disclosure or the accompanying drawings, it should not be understood that these operations or steps are required to be performed in the specific order or serial order as shown, or all illustrated operations or steps are required to be performed to obtain a desired result. In the embodiments of the present disclosure, these operations or steps may be performed in any order without contradiction; alternatively, these operations or steps may be performed in parallel; alternatively, a part of these operations or steps may be performed; alternatively, the operations or steps in the plurality of embodiments or the accompanying drawings may be combined arbitrarily, which is not limited in the present disclosure.

Firstly, the implementation environment of the embodiments of the present disclosure is described below.

The technical solutions of the embodiments of the present disclosure may be applied to various communication systems. The communication system may include one or more of the 4th generation (4G) communication system, the 5th generation (5G) communication system, and another future wireless communication system (such as 6G). The communication system may alternatively include one or more of the Public Land Mobile Network (PLMN) network, the Device-to-Device (D2D) communication system, the Machine to Machine (M2M) communication system, the Internet of Things (IoT) communication system, the Vehicle-to-Everything (V2X) communication system, or another communication system.

FIG. 1 is a schematic diagram of a communication system 100 according to some embodiments of the present disclosure. As shown in FIG. 1, the communication system 100 may include a terminal device 150 and a network device 160. The communication system may be configured to support a 4G network access technology, for example, the Long Term Evolution (LTE) access technology, or a 5G network access technology, such as the New Radio Access Technology (New RAT), or another future wireless communication technology. It should be noted that, in the communication system, there may be one or more network devices and one or more terminal devices. The quantity of the network device and the quantity of the terminal device in the communication system shown in FIG. 1 are merely adaptive examples, which are not limited in the present disclosure.

The network device in FIG. 1 may be configured to support the access of a terminal. For example, the network device may include an evolved NodeB (eNB or eNodeB) in LTE; alternatively, the network device may include a next generation base station (gNB, or gNodeB) in the 5G network; alternatively, the network device may include a next generation radio access network (NG-RAN) device in the 5G network; and alternatively, the network device may include at least one of a base station in a future evolved Public Land Mobile Network (PLMN), a Broadband Network Gateway (BNG), an aggregation switch, or a non-3GPP access device, etc. In some embodiments, the network device in the embodiments of the present disclosure may include at least one of the following forms of base stations, such as a macro base station, a micro base station (also referred to as a small station), a relay station, an access point, a 5G base station or a future base station, a satellite, a transmitting and receiving point (TRP), a transmitting point (TP), a mobile switching center, a Device-to-Device (D2D) device, a Machine-to-Machine (M2M) device, an Internet of Things (IoT) device, a Vehicle-to-Everything (V2X) device, or another device that undertakes a base station function in a communication system, etc., which is not specifically limited in the embodiments of the present disclosure. For ease of description, in all embodiments of the present disclosure, an apparatus that provides a wireless communication function for a terminal device is collectively referred to as a network device or a base station.

The terminal device in FIG. 1 may be an electronic device providing voice or data connectivity. For example, the terminal device may also be referred to as user equipment (UE), a subscriber unit, a mobile station, a station, a terminal, or the like. For example, the terminal device may include a smart phone, a smart wearable device, a smart speaker, a smart tablet, a modem, a wireless local loop (WLL) station, a personal digital assistant (PDA), a customer premise equipment (CPE), or the like. With the development of wireless communication technologies, a device that may access an access a communication system, may communicate with a network device of a communication system, may communicate with another object by using a communication system, or may directly communicate between two or more devices, may be the terminal device in the embodiments of the present disclosure, such as a terminal and an automobile in intelligent transportation, a household device in smart home, a power meter reading instrument in a smart grid, a voltage monitoring instrument, an environment monitoring instrument, a video monitoring instrument in an intelligent security network, a cash register, or the like. In the embodiments of the present disclosure, the terminal device may communicate with the network device. Communication may also be performed between a plurality of terminal devices. The terminal device may be statically fixed or mobile, which is not limited in the present disclosure.

In some embodiments, the terminal device may include a first terminal device supporting a full duplex communication technology. For example, the first terminal device may be a terminal device whose protocol version is equal to or higher than Release 18. For another example, the first terminal device may support a first terminal capability, and the first terminal capability may be used to indicate that the first terminal device supports configuring an uplink frequency band in a downlink time domain resource or a flexible time domain resource, or the first terminal capability may be used to indicate that the first terminal device identifies or uses an uplink frequency band configured in a downlink time domain resource or a flexible time domain resource. The uplink frequency band (UL band) may also be referred to as an uplink sub band (UL sub band).

In some embodiments, the terminal device may alternatively include a second terminal device that does not support the full duplex communication technology. For example, the second terminal device may be a terminal device whose protocol version is equal to or lower than Release 17. For another example, the first terminal device may not support the first terminal capability.

It should be noted that the, in the full duplex communication, it may be that some or all of the time-frequency resources support an uplink transmission and a downlink transmission. For example, some resource blocks (RB) may be used for both the uplink transmission and the downlink transmission, so that the utilization rate of spectrum resources can be improved.

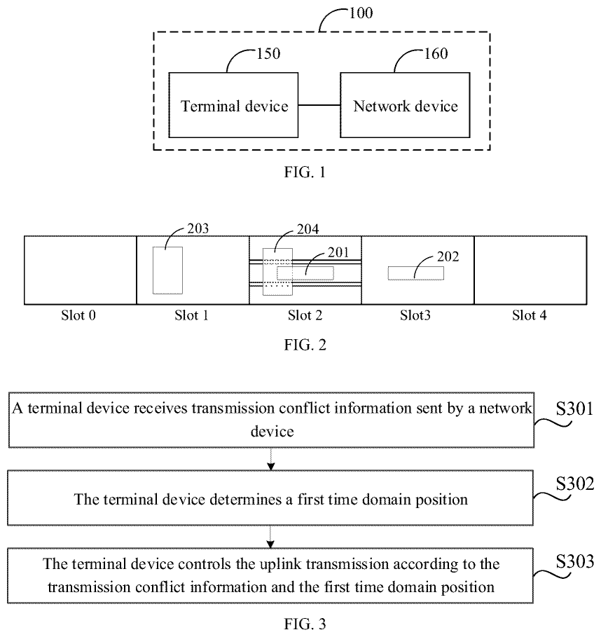

FIG. 2 is a schematic diagram of a communication slot according to some embodiments of the present disclosure. As shown in FIG. 2, slot 0 to slot 4 includes 5 slots, where slot 0 and slot 1 may be slots used for a downlink transmission, slot 3 and slot 4 may be slots used for an uplink transmission, and slot 2 may be used for both the uplink transmission and the downlink transmission. That is, slot 2 may be a slot shared by uplink frequency domain resources and downlink frequency domain resources.

The first terminal device may be a terminal device supporting the full duplex communication technology. The first terminal device may perform the uplink transmission by using the first resource 201 in slot 2, or may perform the uplink transmission by using the second resource 202 in slot 3. The second terminal device may be a terminal device that does not support the full duplex communication technology. The second terminal device may perform the downlink transmission by using the third resource 203 in slot 1, or may perform the downlink transmission by using the fourth resource 204 in slot 2. In this way, the first resource 201 and the fourth resource 204 partially overlap in the time-frequency position, resulting in a conflict between the radio resource used for an uplink transmission and the radio resource used for the downlink transmission. In order to overcome the above problem in the related art, the present disclosure provides a method and apparatus for an uplink transmission, and a storage medium.

FIG. 3 is a flowchart of a method for an uplink transmission according to some embodiments of the present disclosure. The method may be performed by a terminal device in the foregoing communication system. As shown in FIG. 3, the method may include following steps.

In S301, the terminal device receives transmission conflict information sent by a network device.

In some embodiments, the terminal device may receive the transmission conflict information by using a physical downlink control channel (PDCCH).

In some embodiments, the transmission conflict information may be an uplink cancellation indication (UL CI) or a downlink preemption indication (DL PI).

In some embodiments, the transmission conflict information may also be a new type of indication.

In some embodiments, the transmission conflict information may indicate that there is a conflict between a radio resource for an uplink transmission and a radio resource for a downlink transmission. For example, the transmission conflict information may indicate that a same radio resource (for example, an RB) is both used by a first terminal device for an uplink transmission, and used by a second terminal device for a downlink transmission.

In S302, the terminal device determines a first time domain position.

In some embodiments, the first time domain position may include a time domain position shared by an uplink frequency domain resource and a downlink frequency domain resource.

In some embodiments, the first time domain position may include at least one time domain symbol, for example, one time domain symbol, three time domain symbols, or seven time domain symbols.

In some embodiments, the first time domain position may include at least one slot, for example, one slot or two slots.

In some embodiments, the first time domain position may be a time domain position corresponding to the transmission conflict information. For example, the terminal device may determine the first time domain position corresponding to the transmission conflict information.

In some embodiments, the first time domain position may include a time domain position pre-configured by the terminal device.

For example, the terminal device may configure the first time domain position according to a protocol agreement or system requirement.

In some embodiments, the first time domain position may include a time domain position pre-configured by the network device.

For example, the terminal device may determine the first time domain position according to the first parameter received from the network device.

In some embodiments, the first parameter may be used to indicate any one of the following:
a time domain position configured with an uplink frequency band in a downlink time domain resource or a flexible time domain resource, where the uplink frequency band (UL band) may also be referred to as an uplink sub band (UL sub band);
a time domain position, in a case that the terminal device supports a first terminal capability, configured with an uplink frequency band in a downlink time domain resource or a flexible time domain resource, where the first terminal capability is used to indicate that the terminal device supports configuring the uplink frequency band in the downlink time domain resource or the flexible time domain resource; or
a first frequency domain resource, where the first time domain position includes a time domain position corresponding to the first frequency domain resource, and the first frequency domain resource may be an uplink frequency band configured in a downlink time domain resource or a flexible time domain resource.

In this way, the terminal device may determine the first time domain position in any one of the foregoing manners.

In S303, the terminal device controls the uplink transmission according to the transmission conflict information and the first time domain position.

In some embodiments, the manner of controlling the uplink transmission by the terminal device may include at least one of: cancelling the uplink transmission, increasing a power of the uplink transmission, decreasing the power of the uplink transmission, or performing the uplink transmission.

It should be noted that, cancelling the uplink transmission may be used to represent that the network device does not expect that the terminal device sends the uplink transmission at the first time domain position; or, cancelling the uplink transmission may be used to represent that the terminal device does not expect to send the uplink transmission at the first time domain position. Performing the uplink transmission may be used to represent that the terminal device performs the uplink transmission according to a current power, that is, the power is neither increased nor decreased.

In some embodiments, there may be one or more first time domain positions. For different first time domain positions, the manners of controlling the uplink transmission may be the same or different.

In some embodiments, the terminal device may cancel the uplink transmission corresponding to the first time domain position according to the transmission conflict information.

In some embodiments, the terminal device may increase the power of the uplink transmission corresponding to the first time domain position according to the transmission conflict information.

In some embodiments, the terminal device may decrease the power of the uplink transmission corresponding to the first time domain position according to the transmission conflict information.

In some embodiments, there are one or more first time domain positions, the transmission conflict information may include at least one indication identifier, and each indication identifier corresponds to one first time domain position. The terminal device may control the uplink transmission corresponding to the first time domain position according to the indication identifier, where the indication identifier may be at least one bit.

In some embodiments, in a case that the value of the indication identifier is equal to a first preset value, the uplink transmission at the first time domain position corresponding to the indication identifier may be cancelled, so that interference caused by the uplink transmission on the downlink transmission may be avoided, and the reliability of the downlink transmission nay be improved. In some embodiments, in a case that the value of the indication identifier is not equal to the first preset value or equal to a second preset value, the uplink transmission at the first time domain position corresponding to the indication identifier may be continued to be performed.

In some embodiments, in a case that the value of the indication identifier is equal to the first preset value, the power of the uplink transmission at the first time domain position corresponding to the indication identifier may be increased, so that the reliability of the uplink transmission may be improved by increasing the uplink power in the case of presence of an interference from the downlink transmission. In some embodiments, in a case that the value of the indication identifier is not equal to the first preset value or equal to the second preset value, the uplink transmission at the first time domain position corresponding to the indication identifier may be continued to be normally performed, that is, the power of the uplink transmission at the first time domain position is maintained.

In some embodiments, in a case that the value of the indication identifier is equal to the first preset value, the power of the uplink transmission at the first time domain position corresponding to the indication identifier may be reduced, so that the reliability of the downlink transmission may be improved by decreasing the uplink power to reduce the interference on the downlink transmission. In some embodiments, in a case that the value of the indication identifier is not equal to the first preset value or equal to the second preset value, the uplink transmission at the first time domain position corresponding to the indication identifier may be continued to be normally performed, that is, the power of the uplink transmission at the first time domain position is maintained.

In some embodiments, the first preset value is different from the second preset value. For example, the first preset value may be 0, and the second preset value may be 1. For another example, the first preset value may alternatively be 1, and the second preset value may be 0.

In some embodiments, in a case that the value of the indication identifier is equal to a third preset value, the uplink transmission at the first time domain position corresponding to the indication identifier may be cancelled. In a case that the value of the indication identifier is equal to a fourth preset value, the power of the uplink transmission at the first time domain position corresponding to the indication identifier may be increased. In a case that the value of the indication identifier is equal to a fifth preset value, the power of the uplink transmission at the first time domain position corresponding to the indication identifier may be decreased. In a case that the value of the indication identifier is equal to a sixth preset value, the uplink transmission at the first time domain position corresponding to the indication identifier may be continued to be normally performed, that is, the power of the uplink transmission at the first time domain position is maintained.

In some embodiments, the third preset value, the fourth preset value, the fifth preset value, and the sixth preset value may be different from each other.

In the foregoing method, the terminal device receives the transmission conflict information sent by the network device, determines the first time domain position, and controls the uplink transmission according to the transmission conflict information and the first time domain position, where the first time domain position may include a time domain position shared by the uplink frequency domain resource and the downlink frequency domain resource. In this way, for a case that there is a first time domain position shared by the uplink frequency domain resource and the downlink frequency domain resource in the full duplex scenario, the uplink transmission at the first time domain position may be controlled by using the transmission conflict information, thus improving the transmission reliability.

In some embodiments of the present disclosure, the manner in which the terminal device controls the uplink transmission according to the transmission conflict information and the first time domain position may include the following. The terminal device may determine an uplink priority and a downlink priority according to the transmission conflict information, and may control the uplink transmission corresponding to the first time domain position according to the transmission conflict information, the uplink priority, and the downlink priority.

In some embodiments, the uplink priority may be used to indicate a priority of the uplink transmission performed by the terminal device at the first time domain position. For example, the uplink priority may be a priority corresponding to an uplink service transmitted by the terminal device at the first time domain position. The uplink priority may be a priority configured by the network device for the terminal device, or may be a priority reported by the terminal device to the network device.

For example, the terminal device may determine the first time domain position corresponding to the transmission conflict information, and may obtain the service for performing the uplink transmission at the first time domain position.

In some embodiments, the downlink priority is used to indicate a priority of the downlink transmission performed at the first time domain position. For example, the downlink priority may be a priority corresponding to a downlink service transmitted by another terminal device at the first time domain position.

For example, the transmission conflict information may include the downlink priority, and the terminal device may obtain the downlink priority according to the transmission conflict information.

In some embodiments, the values of the uplink priority may include a higher priority and a lower priority. Similarly, the values of the downlink priority may also include a higher priority and a lower priority.

In some embodiments, there may be a plurality of values of the uplink priority. For example, the uplink priority may include any value in 0 to 7, the priority 7 represents the highest priority, and the priority 0 represents the lowest priority. Similarly, there may be a plurality of values of the downlink priority.

In an embodiment of the present disclosure, there may be a plurality of manners in which the terminal device controls the uplink transmission corresponding to the first time domain position according to the transmission conflict information, the uplink priority, and the downlink priority.

In some embodiments, in a case that the uplink priority is the same as the downlink priority, the terminal device may cancel the uplink transmission corresponding to the first time domain position and the uplink transmission corresponding to a fourth time domain position, where the uplink transmission at the first time domain position and the uplink transmission at the fourth time domain position are uplink transmissions indicated by the same piece of uplink scheduling information.

In some embodiments, in a case that the uplink priority is the same as the downlink priority, the terminal device may cancel the uplink transmission corresponding to the first time domain position.

In some embodiments, in a case that the uplink priority is the same as the downlink priority, the terminal device may increase the power of the uplink transmission corresponding to the first time domain position.

In some embodiments, in a case that the uplink priority is a lower priority and the downlink priority is a higher priority, the terminal device may cancel the uplink transmission corresponding to the first time domain position and the uplink transmission corresponding to the fourth time domain position, where the uplink transmission at the first time domain position and the uplink transmission at the fourth time domain position are uplink transmissions indicated by the same piece of uplink scheduling information.

In some embodiments, in a case that the uplink priority is a lower priority and the downlink priority is a higher priority, the terminal device may cancel the uplink transmission corresponding to the first time domain position.

In some embodiments, in a case that the uplink priority is less than or equal to the downlink priority, the terminal device may cancel the uplink transmission corresponding to the first time domain position and the uplink transmission corresponding to the fourth time domain position, where the uplink transmission at the first time domain position and the uplink transmission at the fourth time domain position are uplink transmissions indicated by the same piece of uplink scheduling information.

In some embodiments, in a case that the uplink priority is less than or equal to the downlink priority, the terminal device may cancel the uplink transmission corresponding to the first time domain position.

In this way, the terminal device may control the uplink transmission corresponding to the first time domain position according to the transmission conflict information, the uplink priority, and the downlink priority in any one of the foregoing manners, thus improving transmission reliability.

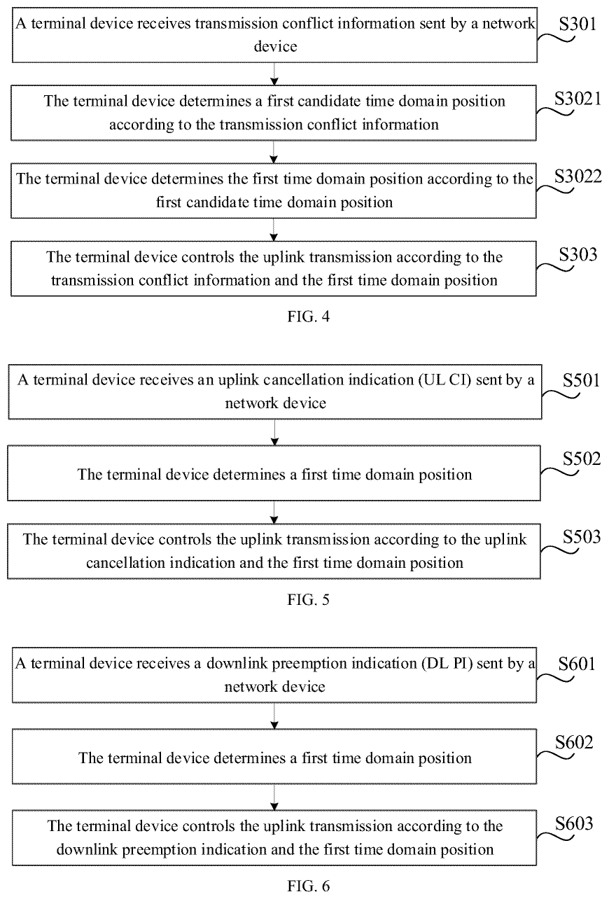

FIG. 4 is a flowchart of a method for an uplink transmission according to some embodiments of the present disclosure. As shown in FIG. 4, the method may include following steps.

In S301, the terminal device receives transmission conflict information sent by a network device.

In S3021, the terminal device determines a first candidate time domain position according to the transmission conflict information.

In some embodiments, the first candidate time domain position may be a time domain position within a first duration after the transmission conflict information is received.

In some embodiments, the first candidate time domain position does not include any one of the following:
a time domain position occupied by a synchronization signal (SS) and/or a physical broadcast channel (PBCH); or
a downlink time domain position indicated by a time division duplex uplink and downlink common configuration (TDD-UL-DL-ConfigurationCommon) not corresponding to the uplink frequency domain resource. For example, there is only the downlink frequency domain resource at the downlink time domain position indicated by the TDD-UL-DL-ConfigurationCommon, and there is no uplink frequency domain resource.

In some embodiments, the first candidate time domain position does not include a time domain position occupied by a synchronization signal (SS), and does not include a time domain position occupied by a physical broadcast channel (PBCH), either.

In some embodiments, the first candidate time domain position does not include a time domain position occupied by a synchronization signal (SS), does not include a time domain position occupied by a physical broadcast channel (PBCH), and does not include a downlink time domain position indicated by a TDD-UL-DL-ConfigurationCommon not corresponding to the uplink frequency domain resource, either.

In this way, the terminal device determines the first candidate time domain position according to the transmission conflict information.

In S3022, the terminal device determines the first time domain position according to the first candidate time domain position.

In some embodiments, the first time domain position may include a time domain position shared by an uplink frequency domain resource and a downlink frequency domain resource among the first candidate time domain position.

In some embodiments, the terminal device may use a time domain position shared by an uplink frequency domain resource and a downlink frequency domain resource among the first candidate time domain position as a second time domain position, and determine the first time domain position according to the second time domain position, where the second time domain position may be a subset or a full set of the first time domain position. For example, the second time domain position may be used as the first time domain position. For another example, a union set of the second time domain position and another time domain position may be used as the first time domain position.

In some embodiments, the terminal device may determine a second candidate time domain position according to the first parameter received from the network device, and determine the first time domain position according to the first candidate time domain position and the second candidate time domain position, where the first time domain position may include an intersection of the first candidate time domain position and the second candidate time domain position.

For example, the intersection of the first candidate time domain position and the second candidate time domain position may be used as a third time domain position, and the first time domain position may be determined according to the third time domain position, where the third time domain position may be a subset or a full set of the first time domain position.

In some embodiments, the second candidate time domain position may be a time domain position configured with an uplink frequency band in a downlink time domain resource or a flexible time domain resource.

In some embodiments, the first parameter may be used to indicate any one of the following:
a time domain position configured with an uplink frequency band in a downlink time domain resource or a flexible time domain resource, where the uplink frequency band (UL band) may also be referred to as an uplink sub band (UL sub band);
a time domain position, in a case that the terminal device supports a first terminal capability, configured with an uplink frequency band in a downlink time domain resource or a flexible time domain resource, where the first terminal capability may be used to indicate that the terminal device supports configuring the uplink frequency band in the downlink time domain resource or the flexible time domain resource; or
a first frequency domain resource, where the first time domain position includes a time domain position corresponding to the first frequency domain resource, and the first frequency domain resource may be an uplink frequency band configured in a downlink time domain resource or a flexible time domain resource.

In some embodiments, the first parameter may be a first parameter sent by the network device and received by the terminal device through a radio resource control (RRC) message, a medium access control element (MAC CE), or a downlink control indication (DCI).

For example, the terminal device may receive an RRC message sent by the network device, where the RRC message may include the first parameter.

In S303, the terminal device controls the uplink transmission according to the transmission conflict information and the first time domain position.

It should be noted that, in the case of no contradiction, this embodiment may be combined with the foregoing embodiments or implementations and various optional solutions of the present disclosure. For the specific implementations of the steps in this embodiment, reference may also be made to the descriptions in the foregoing embodiments of the present disclosure, and details are not described here again.

In this way, the terminal device may determine the first time domain position according to the transmission conflict information, and control the uplink transmission according to the transmission conflict information and the first time domain position.

FIG. 5 is a flowchart of a method for an uplink transmission according to some embodiments of the present disclosure. As shown in FIG. 5, the method may include following steps.

In S501, the terminal device receives an uplink cancellation indication (UL CI) sent by a network device.

In some embodiments, the uplink cancellation indication may include the foregoing transmission conflict information.

In S502, the terminal device determines the first time domain position.

In some embodiments, the first time domain position may be a time domain position corresponding to the uplink cancellation indication. For example, the terminal device may determine the first time domain position corresponding to the uplink cancellation indication.

It should be noted that, in this step, for the specific manner in which the terminal device determines the first time domain position, reference may be made to the description of the step S302 in the foregoing embodiments of the present disclosure, and details are not described here again.

In S503, the terminal device controls the uplink transmission according to the uplink cancellation indication and the first time domain position.

It should be noted that, in this step, for the specific manner in which the terminal device controls the uplink transmission according to the uplink cancellation indication and the first time domain position, reference may be made to the description of step S303 in the foregoing embodiments of the present disclosure, and details are not described here again.

It should also be noted that, in the case of no contradiction, this embodiment may be combined with the foregoing embodiments or implementations and various optional solutions of the present disclosure. For the specific implementations of the foregoing steps in this embodiment, reference may be made to the descriptions in the foregoing embodiments of the present disclosure, and details are not described here again.

In this way, the terminal device may determine the first time domain position according to the uplink cancellation indication, and control the uplink transmission according to the uplink cancellation indication and the first time domain position.

FIG. 6 is a flowchart of a method for an uplink transmission according to some embodiments of the present disclosure. As shown in FIG. 6, the method may include following steps.

In S601, the terminal device receives a downlink preemption indication (DL PI) sent by a network device.

In some embodiments, the downlink preemption indication may include the foregoing transmission conflict information.

In S602, the terminal device determines the first time domain position.

In some embodiments, the first time domain position may be a time domain position corresponding to the downlink preemption indication. For example, the terminal device may determine the first time domain position corresponding to the downlink preemption indication.

It should be noted that, in this step, for the specific manner in which the terminal device determines the first time domain position, reference may be made to the description of the step S302 in the foregoing embodiments of the present disclosure, and details are not described here again.

In S603, the terminal device controls the uplink transmission according to the downlink preemption indication and the first time domain position.

It should be noted that, in this step, for the specific manner in which the terminal device controls the uplink transmission according to the downlink preemption indication and the first time domain position, reference may be made to the description of step S303 in the foregoing embodiments of the present disclosure, and details are not described here again.

It should also be noted that, in the case of no contradiction, this embodiment may be combined with the foregoing embodiments or implementations and various optional solutions of the present disclosure. For the specific implementations of the foregoing steps in this embodiment, reference may be made to the descriptions in the foregoing embodiments of the present disclosure, and details are not described here again.

In this way, the terminal device may determine the first time domain position according to the downlink preemption indication, and control the uplink transmission according to the downlink preemption indication and the first time domain position.

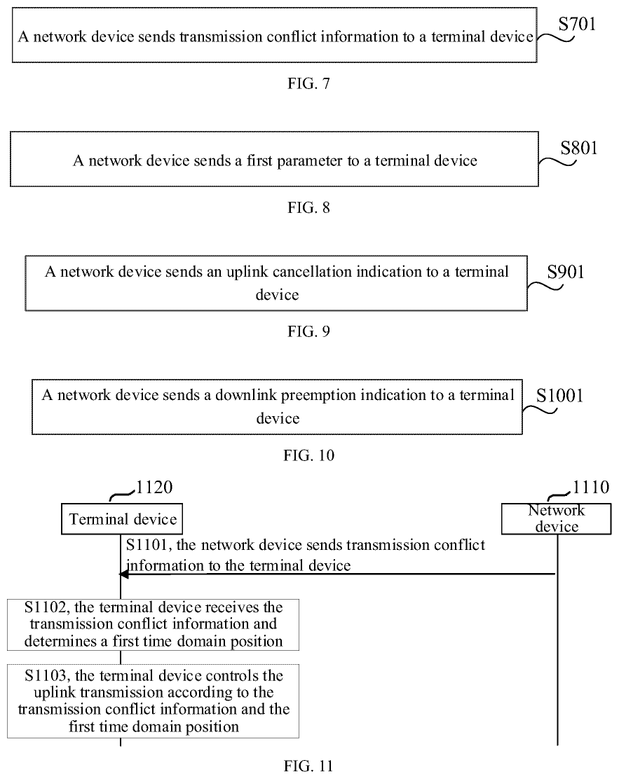

FIG. 7 is a flowchart of a method for an uplink transmission according to some embodiments of the present disclosure. The method may be performed by a network device in the foregoing communication system. As shown in FIG. 7, the method may include the following step.

In S701, the network device sends transmission conflict information to a terminal device.

In some embodiments, the transmission conflict information may be used to indicate the terminal device to determine a first time domain position and control the uplink transmission. The first time domain position may include a time domain position shared by an uplink frequency domain resource and a downlink frequency domain resource.

In some embodiments, the terminal device may control the uplink transmission according to the transmission conflict information and the first time domain position.

In some embodiments, the first time domain position may include at least one time domain symbol, for example, one time domain symbol, three time domain symbols, or seven time domain symbols.

In some embodiments, the first time domain position may include at least one slot, for example, one slot or two slots.

In some embodiments, the network device may send the transmission conflict information by using a physical downlink control channel (PDCCH).

In some embodiments, the transmission conflict information may be an uplink cancellation indication (UL CI) or a downlink preemption indication (DL PI).

In some embodiments, the transmission conflict information may also be a new type of indication.

In some embodiments, when determining that a radio resource for the uplink transmission performed by the terminal device conflicts with a radio resource for the downlink transmission performed by another terminal device, the network device may send the transmission conflict information to the terminal device. For example, the transmission conflict information may indicate that a same radio resource (for example, an RB) is used for both the uplink transmission performed by the first terminal device and the downlink transmission performed by a second terminal device.

In some embodiments, when determining that the terminal device supports the first terminal capability and the radio resource for the uplink transmission performed by the terminal device conflicts with the radio resource for the downlink transmission performed by another terminal device, the network device may send the transmission conflict information to the terminal device, where the first terminal capability is used to indicate that the terminal device supports configuring an uplink frequency band in a downlink time domain resource or a flexible time domain resource.

In some embodiments, when determining that the terminal device supports the first terminal capability, the network device may send the transmission conflict information to the terminal device.

It should be noted that, in the case of no contradiction, this embodiment may be combined with the foregoing embodiments or implementations and various optional solutions of the present disclosure. For the specific implementations of the foregoing steps in this embodiment, reference may be made to the description in the foregoing embodiments of the present disclosure, and details are not described here again.

In this way, the network device may send the transmission conflict information to the terminal device; and, the terminal device may determine the first time domain position, and control the uplink transmission according to the transmission conflict information and the first time domain position, where the first time domain position may include a time domain position shared by the uplink frequency domain resource and the downlink frequency domain resource. In this way, for a case that there is a first time domain position shared by the uplink frequency domain resource and the downlink frequency domain resource in the full duplex scenario, the uplink transmission at the first time domain position may be controlled by using the transmission conflict information, thus improving the transmission reliability.

In some embodiments of the present disclosure, the manner of controlling the uplink transmission by the terminal device may include at least one of: cancelling the uplink transmission, increasing a power of the uplink transmission, decreasing the power of the uplink transmission, or performing the uplink transmission.

It should be noted that, cancelling the uplink transmission may be used to represent that the network device does not expect that the terminal device sends the uplink transmission at the first time domain position; or, cancelling the uplink transmission may be used to represent that the terminal device does not expect to send the uplink transmission at the first time domain position. Performing the uplink transmission may be used to represent that the terminal device performs the uplink transmission according to a current power, that is, the power is neither increased nor decreased.

In some embodiments, there may be one or more first time domain positions. For different first time domain positions, the manners of controlling the uplink transmission may be the same or different.

In some embodiments, the network device may indicate, by using the transmission conflict information, the terminal device to cancel the uplink transmission corresponding to the first time domain position.

In some embodiments, the network device may indicate, by using the transmission conflict information, the terminal device to increase the power of the uplink transmission corresponding to the first time domain position.

In some embodiments, the network device may indicate, by using the transmission conflict information, the terminal device to decrease the power of the uplink transmission corresponding to the first time domain position.

In some embodiments, there are one or more first time domain positions, the transmission conflict information may include at least one indication identifier, and each indication identifier corresponds to one first time domain position. The network device may indicate, by using the indication identifier, the terminal device to control the uplink transmission corresponding to the first time domain position, where the indication identifier may be at least one bit. The network device may first determine the value of the indication identifier, and then send the transmission conflict information including the indication identifier to the terminal device.

In some embodiments, when determining that the first time domain position includes the time domain position shared by the uplink frequency domain resource and the downlink frequency domain resource, the network device sets the value of the indication identifier to a first preset value. The first preset value may be used to indicate the terminal device to cancel the uplink transmission at the first time domain position corresponding to the indication identifier. Alternatively, the first preset value may be used to indicate the terminal device to increase the power of the uplink transmission at the first time domain position corresponding to the indication identifier. Alternatively, the first preset value may be used to indicate the terminal device to decrease the power of the uplink transmission at the first time domain position corresponding to the indication identifier.

In some embodiments, when determining that the first time domain position does not include the time domain position shared by the uplink frequency domain resource and the downlink frequency domain resource, the network device sets the value of the indication identifier to a second preset value. The second preset value may indicate the terminal device to normally perform the uplink transmission at the first time domain position corresponding to the indication identifier, that is, to maintain the power of the uplink transmission at the first time domain position.

In some embodiments, the first preset value is different from the second preset value. For example, the first preset value may be 0, and the second preset value may be 1. For another example, the first preset value may alternatively be 1, and the second preset value may be 0.

In this way, the network device may send the transmission conflict information, and indicate, by using the transmission conflict information, the terminal device to control the uplink transmission.

In some embodiments of the present disclosure, the network device may first obtain an uplink priority and a downlink priority, and send the transmission conflict information to the terminal device according to the uplink priority and the downlink priority.

In some embodiments, the uplink priority may be used to indicate a priority of an uplink transmission performed by the terminal device at the first time domain position, and the downlink priority may be used to indicate a priority of a downlink transmission performed at the first time domain position.

In some embodiments, the uplink priority may be used to indicate the priority of the uplink transmission performed by the terminal device at the first time domain position. For example, the uplink priority may be a priority corresponding to an uplink service transmitted by the terminal device at the first time domain position. The uplink priority may be a priority configured by the network device for the terminal device, or may be a priority reported by the terminal device to the network device.

For example, the terminal device may determine the first time domain position corresponding to the transmission conflict information, and obtain the service for performing the uplink transmission at the first time domain position.

In some embodiments, the downlink priority is used to indicate a priority of the downlink transmission performed at the first time domain position. For example, the downlink priority may be a priority corresponding to a downlink service transmitted by another terminal device at the first time domain position.

For example, the transmission conflict information may include the downlink priority, and the terminal device may obtain the downlink priority according to the transmission conflict information.

In some embodiments, the values of the uplink priority may include a higher priority and a lower priority. Similarly, the values of the downlink priority may also include a higher priority and a lower priority.

In some embodiments, there may be a plurality of values of the uplink priority. For example, the uplink priority may include any value in 0 to 7, the priority 7 represents the highest priority, and the priority 0 represents the lowest priority. Similarly, there may be a plurality of values of the downlink priority.

In the embodiments of the present disclosure, there may be a plurality of manners in which the network device sends the transmission conflict information to the terminal device according to the uplink priority and the downlink priority.

In some embodiments, in a case that the uplink priority is the same as the downlink priority, the transmission conflict information sent by the network device may be used to indicate the terminal device to cancel the uplink transmission corresponding to the first time domain position and the uplink transmission corresponding to a fourth time domain position, where the uplink transmission at the first time domain position and the uplink transmission at the fourth time domain position are uplink transmissions indicated by the same the same piece of uplink scheduling information.

In some embodiments, w in a case that the uplink priority is the same as the downlink priority, the transmission conflict information sent by the network device may be used to indicate the terminal device to cancel the uplink transmission corresponding to the first time domain position.

In some embodiments, in a case that the uplink priority is the same as the downlink priority, the transmission conflict information sent by the network device may be used to indicate the terminal device to increase the power of the uplink transmission corresponding to the first time domain position.

In some embodiments, in a case that the uplink priority is a lower priority and the downlink priority is a higher priority, the transmission conflict information sent by the network device may be used to indicate the terminal device to cancel the uplink transmission corresponding to the first time domain position and the uplink transmission corresponding to the fourth time domain position, where the uplink transmission at the first time domain position and the uplink transmission at the fourth time domain position are uplink transmissions indicated by the same piece of uplink scheduling information.

In some embodiments, in a case that the uplink priority is a lower priority and the downlink priority is a higher priority, the transmission conflict information sent by the network device may be used to indicate the terminal device to cancel the uplink transmission corresponding to the first time domain position.

In some embodiments, in a case that the uplink priority is less than or equal to the downlink priority, the transmission conflict information sent by the network device may be used to indicate the terminal device to cancel the uplink transmission corresponding to the first time domain position and the uplink transmission corresponding to the fourth time domain position, where the uplink transmission at the first time domain position and the uplink transmission at the fourth time domain position are uplink transmissions indicated by the same piece of uplink scheduling information.

In some embodiments, in a case that the uplink priority is less than or equal to the downlink priority, the transmission conflict information sent by the network device may be used to indicate the terminal device to cancel the uplink transmission corresponding to the first time domain position.

In this way, the network device may send the transmission conflict information according to the uplink priority and the downlink priority, and indicate, by using the transmission conflict information, the terminal device to control the uplink transmission.

FIG. 8 is a flowchart of a method for an uplink transmission according to some embodiments of the present disclosure. As shown in FIG. 8, the method may include the following step.

In S801, the network device sends a first parameter to a terminal device.

In some embodiments, the first parameter may be used to indicate the terminal device to determine the first time domain position. For example, the terminal device may determine the first time domain position according to the first parameter.

For example, the network device may send the first parameter to the terminal device by using a radio resource control (RRC) message, a media access control control unit (MAC CE), or a downlink control indication (DCI).

In some embodiments, the first parameter is used to indicate any one of the following:
a time domain position configured with an uplink frequency band in a downlink time domain resource or a flexible time domain resource, where the uplink frequency band (UL band) may also be referred to as an uplink sub band (UL sub band);
a time domain position, in a case that the terminal device supports a first terminal capability, configured with an uplink frequency band in a downlink time domain resource or a flexible time domain resource, where the first terminal capability is used to indicate that the terminal device supports configuring the uplink frequency band in the downlink time domain resource or the flexible time domain resource; or
a first frequency domain resource, where the first time domain position includes a time domain position corresponding to the first frequency domain resource, and the first frequency domain resource may be an uplink frequency band configured in the downlink time domain resource or the flexible time domain resource.

It should be noted that, in the case of no contradiction, this embodiment may be combined with the foregoing embodiments or implementations and various optional solutions of the present disclosure. For the specific implementations of the foregoing steps in this embodiment, reference may be made to the descriptions in the foregoing embodiments of the present disclosure, and details are not described here again.

It should be noted that the step S801 is an optional step, and the step S801 may be performed before the step S701.

In this way, the network device sends the first parameter to the terminal device, and the terminal device may determine the first time domain position according to the first parameter.

FIG. 9 is a flowchart of a method for an uplink transmission according to some embodiments of the present disclosure. As shown in FIG. 9, the method may include the following step.

In S901, the network device sends an uplink cancellation indication to a terminal device.

In some embodiments, the uplink cancellation indication may be used to indicate the terminal device to determine the first time domain position and control the uplink transmission according to the uplink cancellation indication and the first time domain position, where the first time domain position may include a time domain position shared by an uplink frequency domain resource and a downlink frequency domain resource.

It should be noted that, in this step, for the specific manner in which the network device sends the uplink cancellation indication to the terminal device, reference may be made to the description of step S701 in the foregoing embodiments of the present disclosure, and details are not described here again.

Thus, the terminal device controls the uplink transmission according to the uplink cancellation indication and the first time domain position.

It should be noted that, in this step, for the specific manner in which the network device sends the uplink cancellation indication to the terminal device, reference may be made to the description of the network device sending the transmission conflict information to the terminal device in the foregoing embodiments of the present disclosure, and details are not described here again.

In this way, the network device sends the uplink cancellation indication to the terminal device; and, the terminal device may determine the first time domain position according to the uplink cancellation indication, and control the uplink transmission according to the uplink cancellation indication and the first time domain position.

FIG. 10 is a flowchart of a method for an uplink transmission according to some embodiments of the present disclosure. As shown in FIG. 10, the method may include the following step.

In S1001, the network device sends a downlink preemption indication to a terminal device.

In some embodiments, the downlink preemption indication may be used to indicate the terminal device to determine the first time domain position and control the uplink transmission according to the downlink preemption indication and the first time domain position, where the first time domain position may include a time domain position shared by an uplink frequency domain resource and a downlink frequency domain resource.

It should be noted that, in this step, for the specific manner in which the network device sends the downlink preemption indication to the terminal device, reference may be made to the description of the network device sending the transmission conflict information to the terminal device in the foregoing embodiments of the present disclosure, and details are not described here again.

In this way, the network device sends the downlink preemption indication to the terminal device; and, the terminal device may determine the first time domain position according to the downlink preemption indication, and control the uplink transmission according to the downlink preemption indication and the first time domain position.

FIG. 11 is a flowchart of a method for an uplink transmission according to some embodiments of the present disclosure. As shown in FIG. 11, the method may include following steps.

In S1101, the network device 1110 sends transmission conflict information to the terminal device 1120.

In some embodiments, the network device may send the transmission conflict information by using a physical downlink control channel (PDCCH).

In some embodiments, the transmission conflict information may be an uplink cancellation indication (UL CI) or a downlink preemption indication (DL PI).

In some embodiments, the transmission conflict information may also be a new type of indication.

In S1102, the terminal device receives the transmission conflict information, and determines a first time domain position.

In some embodiments, the first time domain position may include a time domain position shared by an uplink frequency domain resource and a downlink frequency domain resource.

In some embodiments, the first time domain position may include a time domain position pre-configured by the terminal device.

For example, the terminal device may configure the first time domain position according to a protocol agreement or system requirement.

In some embodiments, the first time domain position may include a time domain position determined according to a first parameter received from the network device.

In S1103, the terminal device controls the uplink transmission according to the transmission conflict information and the first time domain position.

In some embodiments, the manner of controlling the uplink transmission by the terminal device may include at least one of: cancelling the uplink transmission, increasing a power of the uplink transmission, decreasing the power of the uplink transmission, or performing the uplink transmission.

In some embodiments, there may be one or more first time domain positions. For different first time domain positions, the manners of controlling the uplink transmission may be the same or different.

It should be noted that, in the case of no contradiction, this embodiment may be combined with the foregoing embodiments or implementations and various optional solutions of the present disclosure. For the specific implementations of the foregoing steps in this embodiment, reference may be made to the descriptions in the foregoing embodiments of the present disclosure, and details are not described here again.

In this way, the network device may send the transmission conflict information to the terminal device; and, the terminal device may determine the first time domain position corresponding to the transmission conflict information, and control the uplink transmission according to the transmission conflict information and the first time domain position, where the first time domain position may include a time domain position shared by the uplink frequency domain resource and the downlink frequency domain resource. In this way, for a case that there is a first time domain position shared by the uplink frequency domain resource and the downlink frequency domain resource in the full duplex scenario, the uplink transmission at the first time domain position may be controlled by using the transmission conflict information, thus improving the transmission reliability.

In some embodiments of the present disclosure, the present disclosure further provides a communication system, where the communication system may include a terminal device and a network device, the terminal device may perform the method for the uplink transmission related to the terminal device in the foregoing embodiments of the present disclosure, and the network device may perform the method for the uplink transmission related to the network device in the foregoing embodiments.

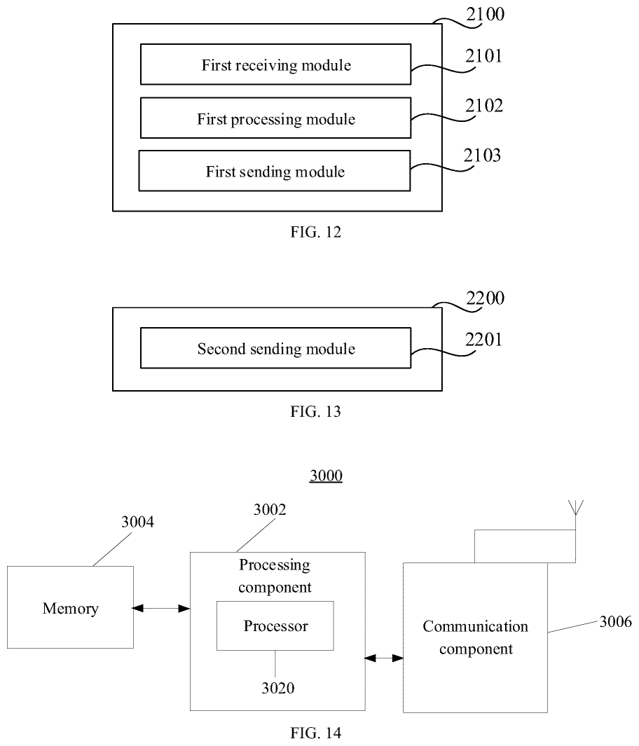

FIG. 12 is a block diagram of an apparatus for an uplink transmission 2100 according to some embodiments of the present disclosure. The apparatus may be applied to a terminal device. As shown in FIG. 12, the apparatus 2100 may include a first receiving module 2101, a first processing module 2102 and a first sending module 2103.

The first receiving module 2101 is configured to receive transmission conflict information sent by a network device.

The first processing module 2102 is configured to determine a first time domain position, where the first time domain position includes a time domain position shared by an uplink frequency domain resource and a downlink frequency domain resource.

The first sending module 2103 is configured to control an uplink transmission according to the transmission conflict information and the first time domain position.

In some embodiments, the first time domain position includes any one of the following:
a time domain position pre-configured by the terminal device; or
a time domain position determined according to a first parameter received from the network device.

In some embodiments, the first parameter is used to indicate any one of the following:
a time domain position configured with an uplink frequency band in a downlink time domain resource or a flexible time domain resource;
a time domain position, in a case that the terminal device supports a first terminal capability, configured with an uplink frequency band in the downlink time domain resource or the flexible time domain resource, where the first terminal capability is used to indicate that the terminal device supports configuring the uplink frequency band in the downlink time domain resource or the flexible time domain resource; or
a first frequency domain resource, where the first time domain position includes a time domain position corresponding to the first frequency domain resource.

In some embodiments, the first processing module 2102 is configured to: determine a first candidate time domain position according to the transmission conflict information, where the first candidate time domain position is a time domain position within a first duration after the transmission conflict information is received; and, determine the first time domain position according to the first candidate time domain position.

In some embodiments, the first processing module 2102 is configured to: use a time domain position shared by an uplink frequency domain resource and a downlink frequency domain resource among the first candidate time domain position as a second time domain position; and, determine the first time domain position according to the second time domain position, where the second time domain position is a subset or a full set of the first time domain position.

In some embodiments, the first processing module 2102 is configured to: determine a second candidate time domain position according to the first parameter received from the network device, where the second candidate time domain position is a time domain position configured with an uplink frequency band in a downlink time domain resource or a flexible time domain resource; use an intersection of the first candidate time domain position and the second candidate time domain position as a third time domain position; and, determine the first time domain position according to the third time domain position, where the third time domain position is a subset or a full set of the first time domain position.

In some embodiments, the first parameter is sent by the network device and received by the terminal device through a radio resource control (RRC) message, a medium access control control element (MAC CE), or a downlink control indication (DCI).

In some embodiments, the first candidate time domain position does not include any one of the following:
a time domain position occupied by a synchronization signal (SS) or a physical broadcast channel (PBCH); or
a downlink time domain position indicated by a time division duplex uplink and downlink common configuration (TDD-UL-DL-ConfigurationCommon) not corresponding to the uplink frequency domain resource.

In some embodiments, the first sending module 2103 is configured to:
cancel the uplink transmission corresponding to the first time domain position according to the transmission conflict information; or
increase or decrease a power of the uplink transmission corresponding to the first time domain position according to the transmission conflict information.

In some embodiments, the first processing module 2102 is further configured to determine an uplink priority and a downlink priority according to the transmission conflict information, where the uplink priority is used to indicate a priority of the uplink transmission performed by the terminal device at the first time domain position, and the downlink priority is used to indicate a priority of a downlink transmission performed at the first time domain position.

The first sending module 2103 is configured to control the uplink transmission corresponding to the first time domain position according to the transmission conflict information, the uplink priority, and the downlink priority.

In some embodiments, the first sending module 2103 is configured to:
cancel the uplink transmission corresponding to the first time domain position and the uplink transmission corresponding to a fourth time domain position in a case that the uplink priority is the same as the downlink priority, where the uplink transmission at the first time domain position and the uplink transmission at the fourth time domain position are uplink transmissions indicated by the same piece of uplink scheduling information; or
cancel the uplink transmission corresponding to the first time domain position in a case that the uplink priority is the same as the downlink priority; or
increase a power of uplink transmission corresponding to the first time domain position in a case that the uplink priority is the same as the downlink priority; or
cancel the uplink transmission corresponding to the first time domain position and an uplink transmission corresponding to a fourth time domain position in a case that the uplink priority is a lower priority and the downlink priority is a higher priority, where the uplink transmission at the first time domain position and the uplink transmission at the fourth time domain position are uplink transmissions indicated by the same piece of uplink scheduling information; or
cancel the uplink transmission corresponding to the first time domain position in a case that the uplink priority is a lower priority and the downlink priority is a higher priority; or
cancel the uplink transmission corresponding to the first time domain position and an uplink transmission corresponding to a fourth time domain position in a case that the uplink priority is less than or equal to the downlink priority, where the uplink transmission at the first time domain position and the uplink transmission at the fourth time domain position are uplink transmissions indicated by the same piece of uplink scheduling information; or
cancel the uplink transmission corresponding to the first time domain position in a case that the uplink priority is less than or equal to the downlink priority.

In some embodiments, the first time domain position includes at least one time domain symbol, or the first time domain position includes at least one slot.

In some embodiments, the transmission conflict information is an uplink cancellation indication (UL CI) or a downlink preemption indication (DL PI).

FIG. 13 is a block diagram of an apparatus for an uplink transmission 2200 according to some embodiments of the present disclosure. The apparatus may be applied to a network device. As shown in FIG. 13, the apparatus 2200 may include a second sending module 2201.

The second sending module 2201 is configured to send transmission conflict information to a terminal device, where the transmission conflict information indicates the terminal device to determine a first time domain position and control an uplink transmission according to the transmission conflict information and the first time domain position, where the first time domain position includes a time domain position shared by an uplink frequency domain resource and a downlink frequency domain resource.

In some embodiments, the second sending module 2201 is configured to:
when determining that a radio resource for an uplink transmission performed by the terminal device conflicts with a radio resource for a downlink transmission performed by another terminal device, send the transmission conflict information to the terminal device; or
when determining that the terminal device supports a first terminal capability and the radio resource for the uplink transmission performed by the terminal device conflicts with the radio resource for the downlink transmission performed by another terminal device, send the transmission conflict information to the terminal device, where the first terminal capability is used to indicates that the terminal device supports configuring an uplink frequency band in a downlink time domain resource or a flexible time domain resource; or
when determining that the terminal device supports the first terminal capability, send the transmission conflict information to the terminal device.

In some embodiments, the second sending module 2201 is further configured to send a first parameter to the terminal device, where the first parameter is used to indicate the terminal device to determine the first time domain position.

In some embodiments, the first parameter is used to indicate any one of the following:
a time domain position configured with an uplink frequency band in a downlink time domain resource or a flexible time domain resource;
a time domain position, in a case that the terminal device supports a first terminal capability, configured with an uplink frequency band in a downlink time domain resource or a flexible time domain resource, where the first terminal capability is used to indicate that the terminal device supports configuring the uplink frequency band in the downlink time domain resource or the flexible time domain resource; or
a first frequency domain resource, where the first time domain position includes a time domain position corresponding to the first frequency domain resource.

In some embodiments, the second sending module 2201 is configured to send the first parameter to the terminal device by using a radio resource control (RRC) message, a media access control control unit (MAC CE), or downlink control indication (DCI).

In some embodiments, the second sending module 2201 is configured to: obtain an uplink priority and a downlink priority, where the uplink priority is used to indicate a priority of an uplink transmission performed by the terminal device at the first time domain position, and the downlink priority is used to indicate a priority of a downlink transmission performed at the first time domain position; and, send the transmission conflict information to the terminal device according to the uplink priority and the downlink priority.

In some embodiments, in a case that the uplink priority is the same as the downlink priority, the transmission conflict information is used to indicate the terminal device to cancel the uplink transmission corresponding to the first time domain position and an uplink transmission corresponding to a fourth time domain position, where the uplink transmission at the first time domain position and the uplink transmission at the fourth time domain position are uplink transmissions indicated by the same piece of uplink scheduling information.

In some embodiments, in a case that the uplink priority is the same as the downlink priority, the transmission conflict information is used to indicate the terminal device to cancel the uplink transmission corresponding to the first time domain position.

In some embodiments, in a case that the uplink priority is the same as the downlink priority, the transmission conflict information is used to indicate the terminal device to increase a power of the uplink transmission corresponding to the first time domain position.

In some embodiments, in a case that the uplink priority is a lower priority and the downlink priority is a higher priority, the transmission conflict information is used to indicate the terminal device to cancel the uplink transmission corresponding to the first time domain position and the uplink transmission corresponding to the fourth time domain position, where the uplink transmission at the first time domain position and the uplink transmission at the fourth time domain position are uplink transmissions indicated by the same piece of uplink scheduling information.

In some embodiments, in a case that the uplink priority is a lower priority and the downlink priority is a higher priority, the transmission conflict information is used to indicate the terminal device to cancel the uplink transmission corresponding to the first time domain position.

In some embodiments, in a case that the uplink priority is less than or equal to the downlink priority, the transmission conflict information is used to indicate the terminal device to cancel the uplink transmission corresponding to the first time domain position and the uplink transmission corresponding to the fourth time domain position, where the uplink transmission at the first time domain position and the uplink transmission at the fourth time domain position are uplink transmissions indicated by the same piece of uplink scheduling information.

In some embodiments, in a case that the uplink priority is less than or equal to the downlink priority, the transmission conflict information is used to indicate the terminal device to cancel the uplink transmission corresponding to the first time domain position.

In some embodiments, the first time domain position includes at least one time domain symbol, or the first time domain position includes at least one slot.

In some embodiments, the transmission conflict information is an uplink cancellation indication (UL CI) or a downlink preemption indication (DL PI).

Regarding the apparatus in the foregoing embodiments, the specific manners in which each module of the apparatus performs operations have been described in detail in the relevant embodiments of the method, and details will not be described here again.

FIG. 14 is a block diagram of an apparatus for an uplink transmission according to some embodiments of the present disclosure. The apparatus for the uplink transmission 3000 may be a terminal device in the communication system shown in FIG. 1, or may be a network device in the communication system.

Referring to FIG. 14, the apparatus 3000 may include one or more of the following components: a processing component 3002, a memory 3004, and a communication component 3006.

The processing component 3002 may be configured to control overall operations of the apparatus 3000, such as operations associated with display, telephone calls, data communications, camera operations, and recording operations. The processing component 3002 may include one or more processors 3020 to execute instructions to complete all or part of the steps of the method for the uplink transmission. In addition, the processing component 3002 may include one or more modules which facilitate the interaction between the processing component 3002 and other components. For example, the processing component 3002 may include a multimedia module to facilitate interaction between the multimedia component and the processing component 3002.

The memory 3004 is configured to store various types of data to support the operations of the apparatus 3000. Examples of such data include instructions for any application or method operating on the apparatus 3000, contact data, phonebook data, messages, pictures, videos, etc. The memory 3004 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 3006 is configured to facilitate wired or wireless communication between the apparatus 3000 and other devices. The apparatus 3000 may access a wireless network based on a communication standard, such as Wi-Fi, 2G, 3G, 4G, 5G, 6G, NB-IoT, eMTC, etc., or a combination of them. In some embodiments, the communication component 3006 receives a broadcast signal or broadcast related information from an external broadcast management system via a broadcast channel. In some embodiments, the communication component 3006 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or other technologies.

In some embodiments, the apparatus 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the method for the uplink transmission described above.

The apparatus 3000 may be an independent electronic device, or may be a part of an independent electronic device. For example, in an embodiment, the electronic device may be an integrated circuit (IC) or a chip, where the integrated circuit may be an IC or a set of more than one IC. The chip may include, but is not limited to, a graphics processing unit (GPU), a central processing unit (CPU), a field programmable gate array (FPGA), a digital signal processor (DSP), an application specific integrated circuit (ASIC), a system on chip (SOC), or the like. The integrated circuit or the chip may be configured to execute an executable instruction (or code) to implement the method for the uplink transmission. In some embodiments, the executable instruction may be stored in the integrated circuit or the chip, or may be obtained from another apparatus or device. For example, the integrated circuit or the chip includes a processor, a memory, and an interface configured to communicate with another apparatus. The executable instruction may be stored in the processor, and the method for the uplink transmission is implemented when the executable instruction is executed by the processor; or the integrated circuit or the chip may receive the executable instruction through the interface and transmit the executable instruction to the processor for execution, to implement the method for the uplink transmission.

In some embodiments, the present disclosure further provides a computer-readable storage medium, on which a computer program instruction is stored. When the program instruction is executed by a processor, the steps of the method for the uplink transmission provided in the present disclosure are implemented. For example, the computer-readable storage medium may be a non-transitory computer-readable storage medium including an instruction. For example, the computer-readable storage medium may be the memory 3004 including an instruction, and the instruction may be executed by the processor 3020 of the apparatus 3000 to complete the method for the uplink transmission. For example, the non-transitory computer-readable storage medium may be a ROM, a random access memory (RAM), a CD-ROM, a magnetic tape, a floppy disk, an optical data storage device, or the like.

In another example embodiment, there is further provided a computer program product including a computer program executable by a programmable apparatus. The computer program has a code portion for performing the method for the uplink transmission described above when executed by the programmable apparatus.

Other embodiments of the present disclosure will be apparent to those skilled in the art from consideration of the description and practice of the present disclosure. The present disclosure is intended to cover any variations, uses, or adaptations of the present disclosure that follow the general principles of the present disclosure and including common general knowledge and conventional technical means in the art and are not disclosed in the present disclosure. It is intended that the description and embodiments should be considered as examples only, with a true scope and spirit of the present disclosure being indicated by the following claims.

It should be understood that the present disclosure is not limited to the precise structures that have been described above and shown in the accompanying drawings, and various modifications and changes may be made without departing from the scope the present disclosure. It is intended that the scope of the present disclosure should only be limited by the appended claims.

1. A method for an uplink transmission, performed by a terminal device, and comprising:
receiving transmission conflict information sent by a network device;
determining a first time domain position, wherein the first time domain position comprises a time domain position shared by an uplink frequency domain resource and a downlink frequency domain resource; and
controlling the uplink transmission according to the transmission conflict information and the first time domain position.

2. (canceled)

3. The method according to claim 1, further comprising:
determining the first time domain position according to a first parameter received from the network device, wherein the first parameter is used to indicate any one of:
a time domain position configured with an uplink frequency band in a downlink time domain resource or a flexible time domain resource;
a time domain position, in a case that the terminal device supports a first terminal capability, configured with an uplink frequency band in a downlink time domain resource or a flexible time domain resource, wherein the first terminal capability is used to indicate that the terminal device supports configuring the uplink frequency band in the downlink time domain resource or the flexible time domain resource; or
a first frequency domain resource, wherein the first time domain position comprises a time domain position corresponding to the first frequency domain resource.

4. The method according to claim 1, wherein determining the first time domain position comprises:
determining a first candidate time domain position according to the transmission conflict information, wherein the first candidate time domain position is a time domain position within a first duration after the transmission conflict information is received; and
determining the first time domain position according to the first candidate time domain position.

5. The method according to claim 4, wherein the first time domain position comprises a time domain position shared by an uplink frequency domain resource and a downlink frequency domain resource among the first candidate time domain position.

6. The method according to claim 4, wherein determining the first time domain position according to the first candidate time domain position comprises:
determining a second candidate time domain position according to a first parameter received from the network device, wherein the second candidate time domain position is a time domain position configured with an uplink frequency band in a downlink time domain resource or a flexible time domain resource; and
determining the first time domain position according to the first candidate time domain position and the second candidate time domain position, wherein the first time domain position comprises an intersection of the first candidate time domain position and the second candidate time domain position.

7. (canceled)

8. The method according to claim 4, wherein the first candidate time domain position does not comprise any one of:
a time domain position occupied by a synchronization signal (SS) or a physical broadcast channel (PBCH); or
a downlink time domain position indicated by a time division duplex uplink and downlink common configuration (TDD-UL-DL-ConfigurationCommon) not corresponding to the uplink frequency domain resource.

9. The method according to claim 1, wherein controlling the uplink transmission according to the transmission conflict information and the first time domain position comprises one of:
cancelling the uplink transmission corresponding to the first time domain position according to the transmission conflict information; or
increasing or decreasing a power of the uplink transmission corresponding to the first time domain position according to the transmission conflict information.

10. The method according to claim 1, further comprising:
determining an uplink priority and a downlink priority according to the transmission conflict information, wherein the uplink priority is used to indicate a priority of the uplink transmission performed by the terminal device at the first time domain position, and the downlink priority is used to indicate a priority of a downlink transmission performed at the first time domain position;
wherein controlling the uplink transmission according to the transmission conflict information and the first time domain position comprises:
controlling the uplink transmission corresponding to the first time domain position according to the transmission conflict information, the uplink priority, and the downlink priority.

11. The method according to claim 10, wherein controlling the uplink transmission corresponding to the first time domain position according to the transmission conflict information, the uplink priority and the downlink priority comprises one of:
cancelling the uplink transmission corresponding to the first time domain position and an uplink transmission corresponding to a fourth time domain position, wherein the uplink transmission at the first time domain position and the uplink transmission at the fourth time domain position are uplink transmissions indicated by a same piece of uplink scheduling information, and the uplink priority is the same as the downlink priority;
cancelling the uplink transmission corresponding to the first time domain position, wherein the uplink priority is the same as the downlink priority;
increasing a power of the uplink transmission corresponding to the first time domain position, wherein the uplink priority is the same as the downlink priority;
cancelling the uplink transmission corresponding to the first time domain position and an uplink transmission corresponding to a fourth time domain position, wherein the uplink transmission at the first time domain position and the uplink transmission at the fourth time domain position are uplink transmissions indicated by a same piece of uplink scheduling information, the uplink priority is a lower priority, and the downlink priority is a higher priority;
cancelling the uplink transmission corresponding to the first time domain position, wherein the uplink priority is a lower priority and the downlink priority is a higher priority; or
cancelling the uplink transmission corresponding to the first time domain position and an uplink transmission corresponding to a fourth time domain position, wherein the uplink transmission at the first time domain position and the uplink transmission at the fourth time domain position are uplink transmissions indicated by a same piece of uplink scheduling information, and the uplink priority is less than or equal to the downlink priority; or
cancelling the uplink transmission corresponding to the first time domain position, wherein the uplink priority is less than or equal to the downlink priority.

12. The method according to claim 1, wherein the first time domain position comprises at least one time domain symbol, or the first time domain position comprises at least one slot;
wherein the transmission conflict information is an uplink cancellation indication (UL CI) or a downlink preemption indication (DL PI).

13. (canceled)

14. A method for an uplink transmission, performed by a network device, and comprising:
sending transmission conflict information to a terminal device;
wherein the transmission conflict information indicates the terminal device to determine a first time domain position and control the uplink transmission, and the first time domain position comprises a time domain position shared by an uplink frequency domain resource and a downlink frequency domain resource.

15. The method according to claim 14, wherein sending the transmission conflict information to the terminal device comprises one of:
determining that a radio resource for the uplink transmission performed by the terminal device conflicts with a radio resource for a downlink transmission performed by another terminal device, and sending the transmission conflict information to the terminal device;
determining that the terminal device supports a first terminal capability, and sending the transmission conflict information to the terminal device, wherein the first terminal capability is used to indicate that the terminal device supports configuring an uplink frequency band in a downlink time domain resource or a flexible time domain resource, and a radio resource for the uplink transmission performed by the terminal device conflicts with a radio resource for a downlink transmission performed by another terminal device; or
determining that the terminal device supports a first terminal capability, and sending the transmission conflict information to the terminal device.

16. The method according to claim 14, further comprising:
sending a first parameter to the terminal device by using a radio resource control (RRC) message, a media access control control unit (MAC CE), or a downlink control indication (DCI), wherein the first parameter is used to indicate the terminal device to determine the first time domain position;
wherein the first parameter is used to indicate one of:
a time domain position configured with an uplink frequency band in a downlink time domain resource or a flexible time domain resource;
a time domain position, in a case that the terminal device supports a first terminal capability, configured with an uplink frequency band in a downlink time domain resource or a flexible time domain resource, wherein the first terminal capability is used to indicate that the terminal device supports configuring the uplink frequency band in the downlink time domain resource or the flexible time domain resource; or
a first frequency domain resource, wherein the first time domain position comprises a time domain position corresponding to the first frequency domain resource.

17. (canceled)

18. (canceled)

19. The method according to claim 14, wherein sending the transmission conflict information to the terminal device comprises:
obtaining an uplink priority and a downlink priority, wherein the uplink priority is used to indicate a priority of the uplink transmission performed by the terminal device at the first time domain position, and the downlink priority is used to indicate a priority of a downlink transmission performed at the first time domain position; and
sending the transmission conflict information to the terminal device according to the uplink priority and the downlink priority.

20. The method according to claim 19, wherein, the uplink transmission is controlled in one of following manners:
the uplink transmission corresponding to the first time domain position and an uplink transmission corresponding to a fourth time domain position are cancelled, wherein the uplink transmission at the first time domain position and the uplink transmission at the fourth time domain position are uplink transmissions indicated by a same piece of uplink scheduling information, and the uplink priority is the same as the downlink priority;
the uplink transmission corresponding to the first time domain position is cancelled, wherein the uplink priority is the same as the downlink priority;
a power of the uplink transmission corresponding to the first time domain position is increased, wherein the uplink priority is the same as the downlink priority;
the uplink transmission corresponding to the first time domain position and an uplink transmission corresponding to a fourth time domain position are cancelled, wherein the uplink transmission at the first time domain position and the uplink transmission at the fourth time domain position are uplink transmissions indicated by a same piece of uplink scheduling information, the uplink priority is a lower priority, and the downlink priority is a higher priority;
the uplink transmission corresponding to the first time domain position is cancelled, wherein the uplink priority is a lower priority and the downlink priority is a higher priority;
the uplink transmission corresponding to the first time domain position and an uplink transmission corresponding to a fourth time domain position are cancelled, wherein the uplink transmission at the first time domain position and the uplink transmission at the fourth time domain position are uplink transmissions indicated by a same piece of uplink scheduling information, and the uplink priority is less than or equal to the downlink priority; or
the uplink transmission corresponding to the first time domain position is cancelled, wherein the uplink priority is less than or equal to the downlink priority.

21. The method according to claim 14, wherein the first time domain position comprises at least one time domain symbol, or the first time domain position comprises at least one slot;
wherein the transmission conflict information is an uplink cancellation indication (UL CI) or a downlink preemption indication (DL PI).

22.-24. (canceled)

25. A terminal device, comprising:
a processor; and
a memory for storing an executable instruction by the processor;
wherein the processor is configured to:
receive transmission conflict information sent by a network device;
determine a first time domain position, wherein the first time domain position comprises a time domain position shared by an uplink frequency domain resource and a downlink frequency domain resource; and
control the uplink transmission according to the transmission conflict information and the first time domain position.

26. A non-transitory computer-readable storage medium having a computer program instruction stored thereon, wherein the computer program instruction, when executed by a processor, causes to implement steps of the method according to claim 1.

27. (canceled)

28. A network device, comprising:
a processor; and
a memory for storing an executable instruction by the processor;
wherein the processor is configured to perform steps of the method according to claim 14.

29. A non-transitory computer-readable storage medium having a computer program instruction stored thereon, wherein the computer program instruction, when executed by a processor, causes to implement steps of the method according to claim 14.
